(19) United States
(12) Patent Application Publication
(10) Pub. No.: US 2011/0220773 A1
(43) Pub. Date: Sep. 15, 2011

(54) Method for the Manufacture of Prefabricated Reinforced Mortar Panels and Slabs

(76) Inventor: Carlos Fradera Pellicer, L'Aldosa, La Massana (AD)

(21) Appl. No.: 13/126,264

(22) PCT Filed: Oct. 28, 2008
(86) PCT No.: PCT/ES2008/000664

§ 371 Date: May 26, 2011

(51) Int. Cl. B29C 33/62

(52) U.S. Cl. 249/115

(57) ABSTRACT

A method for the manufacture of prefabricated reinforced mortar panels and slabs, particularly one in which metal molds are used that have resistant means to withstand the stressing of biaxial reinforcement members. According to the method, a mold (3) is provided that is formed by two parallel central walls (2, 5), forming the major faces of the panel, two sidewalls (9), which connect the sides of the central walls (2, 5) and form the lateral edges of the panel, and two end walls which connect the end edges of the central (2, 5) and sidewalls (9), and form the end edges of the panel. A stressed reinforcement member (7, 8) is provided biaxially between the sidewalls (9) and the end walls. Finally, mortar is introduced through an operable space provided in one of the central walls (2, 5), side walls (9) and/or end walls.

### OBJECT OF THE INVENTION

The present invention relates to a method for the manufacture of prefabricated reinforced mortar panels and slabs, particularly one in which metal molds are used that have resistant means to withstand the stressing of biaxial reinforcement members and is organized so that both flat and curved panels and slabs, biaxially prestressed, can be obtained, as prefabricated items.

### BACKGROUND OF THE INVENTION

Some patents are known in which shuttering for the construction of walls of curved surface are contemplated, such as the patents ES 2 084 868, ES 2 141 010 and ES 2 178 604, in all of which it is seen that they refer to shuttering arrangements that allow the construction of concrete walls “in situ” having a curved surface and, in all cases, with the sole possibility of being reinforced with non-prestressed reinforcement members and only in the sense of the generatrix of the curve.

In these cases it is impossible to obtain prefabricated panels and slabs having a curved surface and with biaxially prestressed reinforcement members.

On the other hand, the traditional methods of molding reinforced mortar panels and slabs, up to now practically only of flat configuration, use open top horizontal molds, which make it difficult to obtain a correct setting because of the evaporation of the water from the mortar, and which require their molding surface to be covered by of a mold stripping agent.

### DESCRIPTION OF THE INVENTION

With the purpose of being able to manufacture panels and slabs as prefabricated items of any configuration, having either a flat, curve, warped or spherical surface and with prestressed biaxial reinforcement members, at the same time as to avoid an undesired evaporation of the water from the mortar in the setting process, the solution has been adopted of molding the said panels and slabs in closed molds and with guide means for the reinforcement members in curved trajectories.

According to the preceding solution the method for the manufacture of prefabricated reinforced mortar panels and slabs has been developed which is the object of the invention, which consists of the fact that there is provided a mold that, being capable of being placed in the vertical or horizontal position, is formed by two parallel central walls, forming the major faces of the panel, two sidewalls, which connect the sides of the central walls and form the lateral edges of this panel, and two upper or front and lower or rear end walls depending on the positioning of the mold, which connect the end edges of the central and sidewalls, either upper or front and lower or rear and form the end edges of the panel, there being provided biaxially a stressed reinforcement member between the sidewalls and the end walls, after which mortar is introduced through an operable space provided in one of the central, side and/or end walls.

One feature of the invention consists of, in one embodiment, the parallel central walls, the sidewalls and the end walls having a flat rectangular configuration, whereas in another embodiment the central walls have a curved configuration in, at least, one of their dimensions, the sidewalls are rectangular and substantially flat, whereas the end walls are flat and have an arcuate, preferably annular, configuration.

A further feature of the invention is that the parallel central walls, the sidewalls and the end walls have a Teflon coating on their molding face.

Yet another feature of the invention is that, in the case of flat panels and slabs, the stressed reinforcement members between the sidewalls and the end walls are in planes parallel to the central walls and form two orthogonal groups, in each one of which the reinforcement members follow rectilinear trajectories parallel to each other, whereas, in the case of curved panels and slabs, the stressed reinforcement members between the sidewalls follow uneven parallel trajectories forming vertices located on an imaginary arc and supported on support members inserted perpendicularly in the convex face of the central wall having the smaller dimension of curvature.

Another feature of the invention is that the central wall having the smaller dimension of curvature has on its concave face, perpendicularly thereto, transverse reinforcement means to withstand the stresses exerted by the uneven trajectory reinforcement members due to the stressing thereof, at the same time as the transverse reinforcement means, which are disposed parallel to each other, in the central wall having smaller curvature, are connected by means of spacer bars perpendicular thereto.

Finally, other features that constitute details of the invention will be disclosed throughout the description thereof that will be developed below.

### BRIEF DESCRIPTION OF THE DRAWINGS

In order to facilitate the understanding of the foregoing ideas, there is described hereinafter the method for the manufacture of prefabricated reinforced mortar panels and slabs using preferred means for obtaining them, with reference to the illustrative drawings attached hereto. In the drawings:

FIG. 1 schematically shows the functional principle of a mold for the manufacture of an arcuate panel with the installation of the prestressed biaxial reinforcement members.

FIG. 2 is a top view of a central portion of an embodiment of a mold made according to the scheme of the previous Figure.

FIG. 3 is a perspective view of the mold of the previous Figure seen from its face having the smaller radius of curvature, in which the transverse reinforcement means are to be seen.

FIG. 4 is a perspective view of an embodiment of a support member for a point of intersection of the reinforcement members.

FIG. 5 is a perspective view of another embodiment of a support member for a point of intersection of the reinforcement members that is functionally equivalent to that of the previous Figure.

FIG. 6 is a perspective view of a variant of the embodiment of the support member of the previous Figure.

FIG. 7 is a top view, partly in cross section, of a possible embodiment of the operable closing means that join the central walls to the sidewalls during the molding operation.

### DESCRIPTION OF AN EMBODIMENT OF THE INVENTION

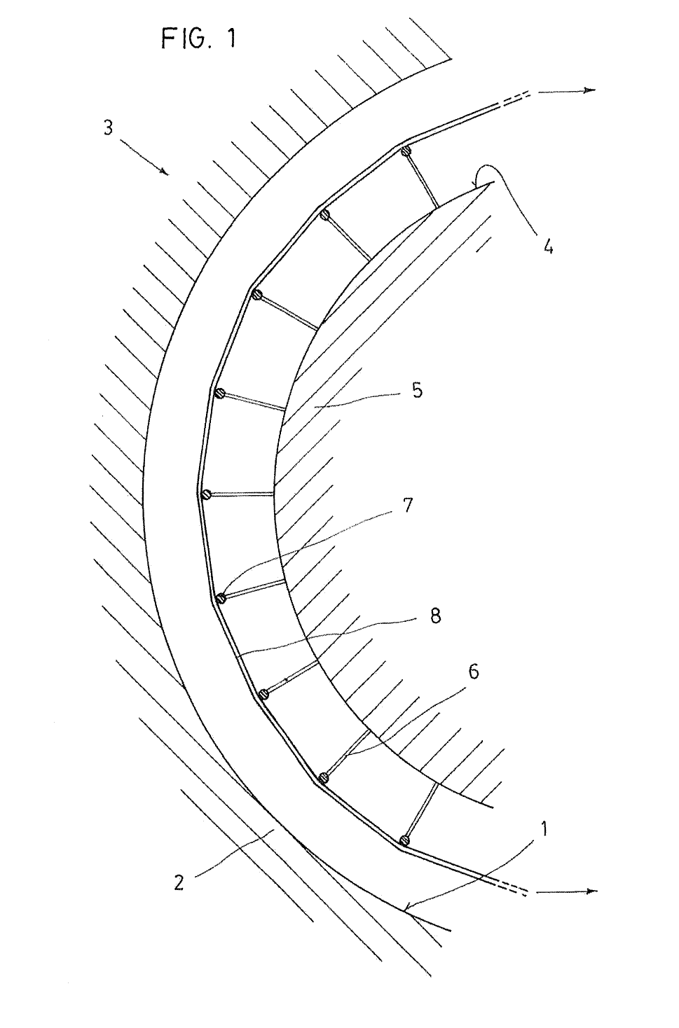

In FIG. 1 there is shown the functional principle of the invention applied to the case in which the method of the invention is for obtaining a curved panel or slab.

Thus, there is shown the concave face 1 of a major central wall 2 of a mold 3 for curved panels that is parallel to the convex face 4 of a minor central wall 5, in which there are installed support members 6 for the longitudinal 7 and transverse 8 prestressed reinforcement members.

The space between these central major 2 and minor 5 walls, in which the longitudinal 7 and transverse 8 reinforcement members with their support members 6 are incorporated, is for receiving the mass of mortar to be molded. The said longitudinal 7 and transverse 8 reinforcement members 7 will be embedded in said mass with their support members 6 that will be unattached to the minor central wall 5.

In order to reduce the method of the invention to practice, it is necessary to have a mold 3, capable of being placed in the vertical or horizontal position, which is formed by two central major 2 and minor 5 walls which, being parallel, will form the major faces of the panel and two sidewalls 9, that connect the sides of central major 2 and minor 5 walls and form the side edges of the panel. The mold 3 is also formed by two end walls, not shown in the drawings as being expected, that are upper or front, and lower or rear, according to the positioning of the mold. These, two end walls connect the end edges of central walls 2 and 5 and sidewalls 9, as being upper or front and lower or rear, and form the end edges of the panel. Finally, the longitudinal 7 and transverse 8 reinforcement members are arranged biaxially, stressed between the sidewalls 9 and the end walls, after which mortar is poured through a operable space provided in one of the central walls 2, 5, sidewalls 9 and/or end walls, which have not been shown either as in the previous case.

The invention contemplates the cases in which the parallel central walls 2, 5, the sidewalls 9 and end walls are of flat rectangular configuration, as well as the cases currently treated in which the said parallel central major 2 and minor 5 walls have a curved configuration in only one of their dimensions, the sidewalls 9 are rectangular and flat and the end walls are flat with an arcuate configuration.

In FIGS. 1, 2 and 3 it is to be seen that longitudinal 7 and transverse 8 reinforcement members stressed between the sidewalls 9 and end walls are in surfaces parallel to the central major 2 and minor 5 walls and form two orthogonal groups, in each of which the reinforcement members 7, 8 follow rectilinear trajectories parallel to each other, in the case where said central walls are flat, whereas the longitudinal 7 and transverse 8 reinforcement members stressed between the sidewalls 9 follow uneven parallel trajectories forming vertices located in an imaginary arc and supported on support members 6 inserted perpendicularly in the convex face 4 of the minor central wall 5.

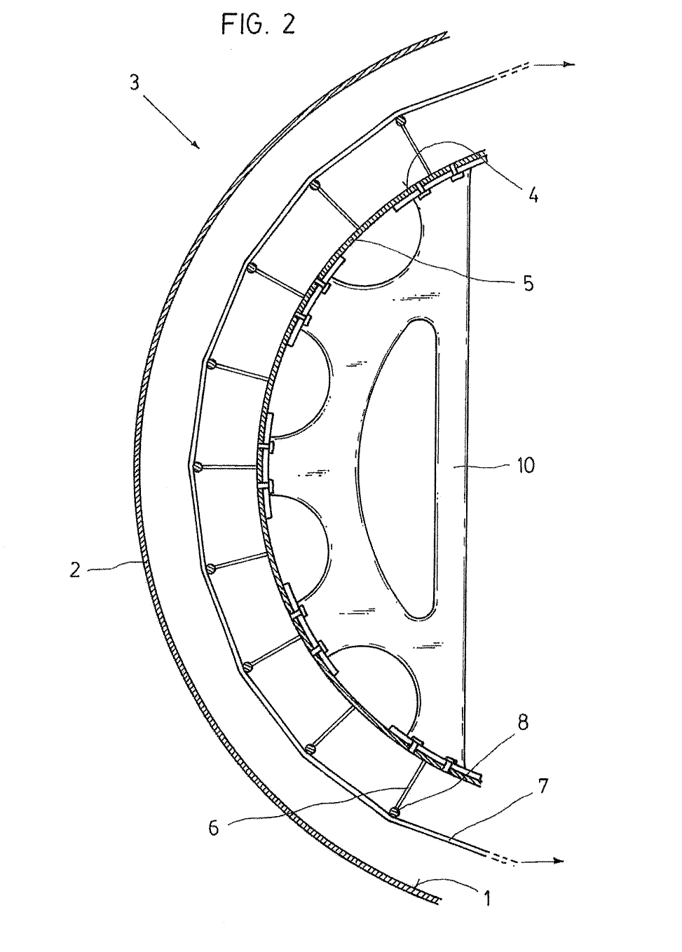

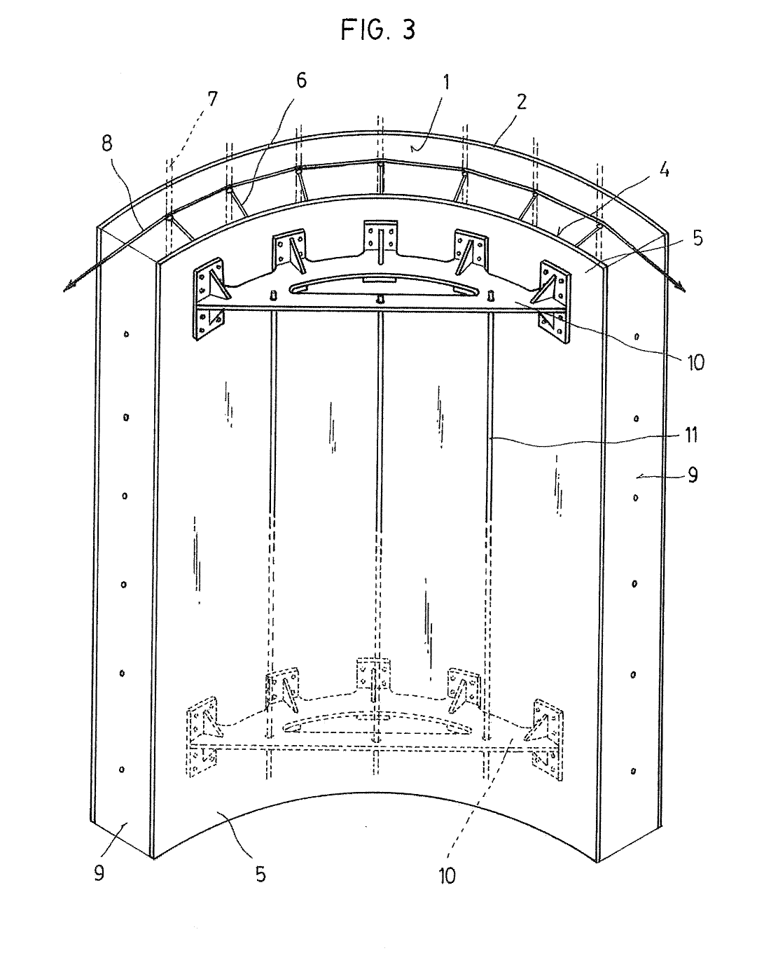

In FIGS. 2 and 3, it is to be seen that the minor central wall 5 has in its concavity and perpendicularly thereto transverse reinforcement means 10 to withstand the stresses exerted by the reinforcement members of uneven trajectory due to the stressing thereof. These transverse reinforcement means 10 are disposed parallel to each other in the minor central wall 5 and are connected by means of spacer bars 11 perpendicular thereto.

On the other hand, as shown in FIG. 7, the sidewalls 9, and also the end walls, in a case not shown, are connected to the central major 2 and minor 5 walls by operable closing means 12.

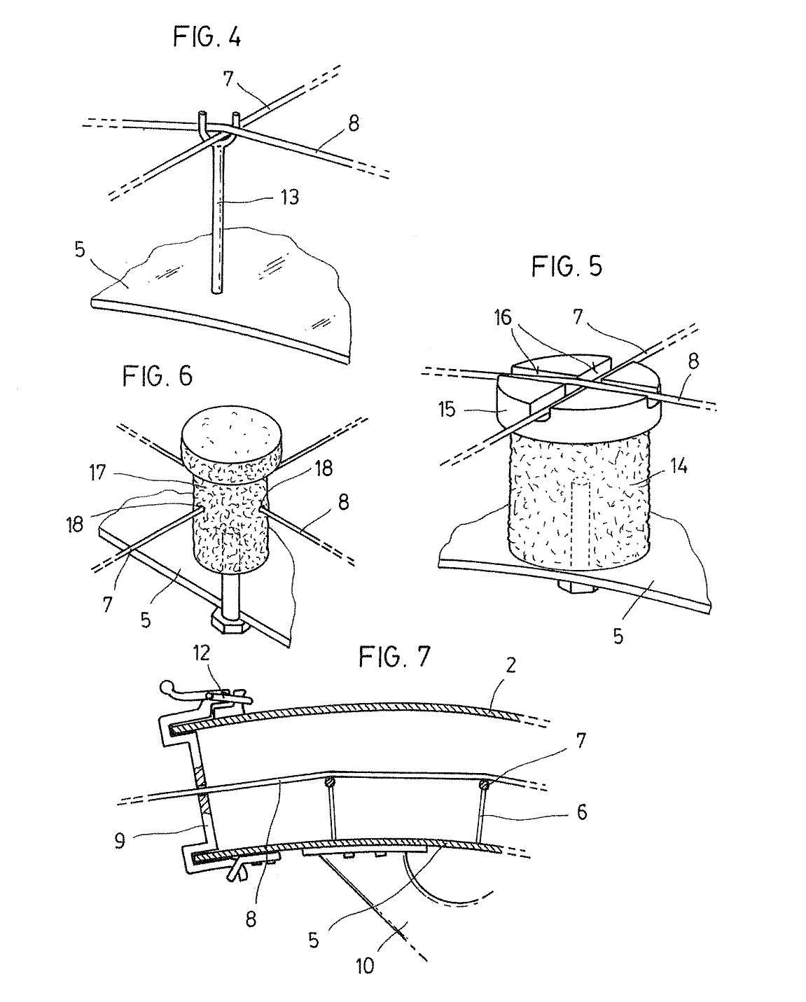

FIG. 4 shows a variant of the support member 6 that is formed by a forked rod 13.

Other embodiments of the support members 6 comprise, in FIG. 5, a body 14 with a head 15 provided with two orthogonal grooves 16 for guiding and seating the points of intersection of the stressed longitudinal 7 and transverse 8 reinforcement members and, in FIG. 6, they comprise a body 17 provided with two diametrical through holes 18, located orthogonally in two adjacent parallel planes, in the vicinity of a head 19 through which the longitudinal 7 and transverse 8 reinforcement members pass.

In all the cases it is contemplated that mold 3, both in its curved version and in the not shown flat version, may comprise, in at least its central major 2 and minor 5 walls, a jacket for the circulation of a heat conditioned fluid.

1. A method for the manufacture of prefabricated reinforced mortar panels and slabs, in which metal molds are used that have resistant means to withstand the stressing of biaxial reinforcement members, characterized in that there is provided a mold (3) that, being capable of adopting a vertical or horizontal position, is formed by two parallel central walls (2, 5), forming the major faces of the panel, two sidewalls (9), which connect the sides of the central walls (2, 5) and form the lateral edges of said panel, and two upper or front and lower or rear end walls depending on the positioning of the mold, which connect the end edges of said central walls (2, 5) and sidewalls (9), either upper or front and lower or rear, and form the end edges of the panel, there being provided biaxially a reinforcement member (7, 8) stressed between said sidewalls (9) and said end walls, after which mortar is introduced through an operable space provided in one of the central walls (2,5), side walls (9) and/or end walls.

2. The method for the manufacture of prefabricated reinforced mortar panels and slabs according to claim 1, characterized in that said parallel central walls (2, 5), said sidewalls (9) and said end walls are of flat rectangular configuration.

3. The method for the manufacture of prefabricated reinforced mortar panels and slabs according to claim 1, characterized in that said parallel central walls (2, 5) are of curved configuration in only one of their dimensions, said sidewalls (9) are rectangular and flat and said end walls are flat with an arcuate configuration.

4. The method for the manufacture of prefabricated reinforced mortar panels and slabs according to claim 1, characterized in that said parallel central walls (2, 5), said sidewalls (9) and said end walls have a Teflon coating on their molding surface.

5. The method for the manufacture of prefabricated reinforced mortar panels and slabs according to claim 2, characterized in that said reinforcement members (7, 8) stressed between said sidewalls (9) and said end walls are in planes parallel to said central walls (2, 5) and constitute two orthogonal groups, in each one of which said reinforcement members (7, 8) follow rectilinear trajectories parallel to each other.

6. The method for the manufacture of prefabricated reinforced mortar panels and slabs according to claim 3, characterized in that said reinforcement members (7, 8) stressed between said sidewalls (9) follow uneven parallel trajectories forming vertices located on an imaginary arc and supported on support members (6) inserted perpendicularly in the convex face (4) of the central wall (5) of smaller dimension of curvature.

7. The method for the manufacture of prefabricated reinforced mortar panels and slabs according to claim 3, characterized in that said central wall (5) of smaller dimension of curvature is provided on the concave face thereof, perpendicularly to said concave face, with transverse reinforcement means (10) to withstand the stresses exerted by said reinforcement members (8) of uneven trajectory due to the stressing thereof.

8. The method for the manufacture of prefabricated reinforced mortar panels and slabs according to claim 1, characterized in that said sidewalls (9) and said end walls are connected to said central walls (2, 5) through operable closing means (12).

9. The method for the manufacture of prefabricated reinforced mortar panels and slabs according to claim 7, characterized in that said transverse reinforcement means (10) disposed parallel to each other in said central wall (5) of smaller curvature are connected by spacer bars (11) perpendicular to said transverse reinforcement means (10).

10. The method for the manufacture of prefabricated reinforced mortar panels and slabs according to claim 5, characterized in that the support members (6) comprise a head (15) provided with two orthogonal grooves (16) for guiding and seating the points of intersection of the stressed reinforcement members (7, 8).

11. The method for the manufacture of prefabricated reinforced mortar panels and slabs according to claim 6, characterized in that the support members (6) comprise two diametrical through holes (18), located orthogonally in two adjacent parallel planes in the vicinity of the head thereof.

12. The method for the manufacture of prefabricated reinforced mortar panels and slabs according to claim 1, characterized in that the mold includes, in at least its central walls (2, 5), a jacket for the circulation of a heat conditioned fluid.
